(19) United States
(12) Patent Application Publication
(10) Pub. No.: US 2026/0044967 A1
(43) Pub. Date: Feb. 12, 2026

(54) MOBILE BODY TRACKING APPARATUS, METHOD, AND COMPUTER READABLE MEDIUM

(71) Applicant: NEC Corporation, Minato-ku, Tokyo (JP)

(72) Inventor: Hiroshi YOSHIDA, Tokyo (JP)

(73) Assignee: NEC Corporation, Minato-ku, Tokyo (JP)

(21) Appl. No.: 19/100,618

(22) PCT Filed: Aug. 16, 2022
(86) PCT No.: PCT/JP2022/030948

§ 371 Date: Feb. 3, 2025

(51) Int. Cl. G06T 7/246; G06V 20/54

(52) U.S. Cl. CPC G06T 7/248; G06V 20/54; G06T 2207/30236; G06V 2201/08

(57) ABSTRACT

Detection means detects a mobile body from each of time-series images obtained by capturing images of a road. Prediction means predicts a destination area of the mobile body by using past information indicating positions where mobile bodies have been detected on the road in the past. In a case where the mobile body is detected from a second image in the destination area that is predicted for the mobile body detected from the first image, tracking means tracks the mobile body detected from the first image and the mobile body detected from the second image as the same mobile body.

### TECHNICAL FIELD

The present disclosure relates to a mobile body tracking apparatus, a method, and a computer readable medium.

### BACKGROUND ART

As related art, Patent Literature 1 discloses a mobile body tracking apparatus that tracks a mobile body included in a plurality of images captured in a time series. The mobile body tracking apparatus acquires pair characteristics of a vehicle to be tracked from the t-th image captured by a camera, and then searches for a destination area of the vehicle to be tracked in the t+1-th image captured by the camera. In the search processing of the destination area, the mobile body tracking apparatus extracts a large number of image areas which are candidates for the destination from the t+1-th image. The image areas which are the candidates for the destination can be determined by predicting a moving direction and a moving speed of the vehicle from the result of the previous vehicle tracking.

The mobile body tracking apparatus searches for a destination candidate that is most similar to the positive sample of the t-th image from among a plurality of destination candidates extracted from the t+1-th image based on the pair features, thereby searching for a destination area of the vehicle. Specifically, the mobile body tracking apparatus extracts a pixel pair from the same position as a plurality of pixel pairs extracted as the pair features of the positive sample in each of the image areas of the destination candidates. The mobile body tracking apparatus calculates a degree of similarity between the positive sample and each of the destination candidates by using the pair features (the pixel pair) of the positive sample and the pixel pair extracted from the destination candidate. The mobile body tracking apparatus calculates a degree of similarity between each of the plurality of destination candidates extracted from the t+1-th image and the positive sample, and determines the destination candidate having the highest degree of similarity as the final destination of the vehicle to be tracked.

### CITATION LIST

### Patent Literature

Patent Literature 1: Japanese Unexamined Patent Application Publication No. 2011-118450

### SUMMARY OF INVENTION

### Technical Problem

In Patent Literature 1, a vehicle is tracked by searching for an area in which pair features are similar among time-series images. However, in a case where the number of feature values is small, it is possible to detect the vehicle from the images, but it is difficult to track the vehicle between the time-series images. In particular, in a case where the frame rate of a camera is low, the amount of movement of the vehicle between the time-series images is large, and it is difficult to track the vehicle between the time-series images.

In Patent Literature 1, the mobile body tracking apparatus extracts a large number of destination candidates in the t+1-th image, and determines a destination of the vehicle to be tracked based on the pair features. Regarding the extraction of destination candidates, Patent Literature 1 discloses that a moving direction and a moving speed of the vehicle are predicted from the result of the previous vehicle tracking. However, in Patent Literature 1, since the result of the previous vehicle tracking is used for the extraction of destination candidates, there is a problem that the accuracy of tracking of the vehicle is reduced in a situation where the tracking is difficult.

In view of the above circumstances, an object of the present disclosure is to provide a mobile body tracking apparatus, a method, and a computer readable medium capable of accurately tracking a mobile body between time-series images.

### Solution to Problem

To achieve the above object, the present disclosure provides, as a first example aspect, a mobile body tracking apparatus. The mobile body tracking apparatus includes: detection means for detecting a mobile body from each of time-series images obtained by capturing images of a road: prediction means for predicting a destination area of the mobile body by using past information indicating positions where mobile bodies have been detected on the road in the past; and tracking means for, in a case where the mobile body is detected from a second image in the destination area that is predicted for the mobile body detected from a first image included in the time-series images, the second image being captured at a time later than a time at which the first image has been captured, tracking the mobile body detected from the first image and the mobile body detected from the second image as the same mobile body.

The present disclosure provides, as a second example aspect, a mobile body tracking method. The mobile body tracking method includes: detecting a mobile body from a first image included in time-series images obtained by capturing images of a road: predicting a destination area of the mobile body detected from the first image by using past information indicating positions where mobile bodies have been detected on the road in the past: detecting the mobile body from a second image captured at a time later than a time at which the first image has been captured, the second image being included in the time-series images; and tracking, in a case where the mobile body detected from the second image is detected in the destination area that is predicted for the mobile body detected from the first image, the mobile body detected from the first image and the mobile body detected from the second image as the same mobile body.

The present disclosure provides, as a third example aspect, a computer readable medium. The computer readable medium stores a program for causing a computer to execute processing including: detecting a mobile body from a first image included in time-series images obtained by capturing images of a road; predicting a destination area of the mobile body detected from the first image by using past information indicating positions where mobile bodies have been detected on the road in the past: detecting the mobile body from a second image captured at a time later than a time at which the first image has been captured, the second image being included in the time-series images; and tracking, in a case where the mobile body detected from the second image is detected in the destination area that is predicted for the mobile body detected from the first image, the mobile body detected from the first image and the mobile body detected from the second image as the same mobile body.

### Advantageous Effects of Invention

A mobile body tracking apparatus, a method, and a computer readable medium according to the present disclosure can accurately track a mobile body between time series images.

### BRIEF DESCRIPTION OF DRAWINGS

FIG. 1 is a block diagram showing an example of a schematic configuration of a mobile body tracking apparatus according to the present disclosure;

FIG. 2 is a block diagram showing a mobile body tracking apparatus according to an example embodiment of the present disclosure:

FIG. 3 is a flowchart showing an operation procedure in the mobile body tracking apparatus:

FIG. 4 is a schematic diagram showing a state of an intersection at a time t:

FIG. 5 is a schematic diagram showing a state of the intersection at a time t+1:

FIG. 6 is a schematic diagram showing a state of the intersection at a time t+2:

FIG. 7 is a schematic diagram showing a state of the intersection in a certain situation; and

FIG. 8 is a block diagram showing an example of a configuration of a computer apparatus.

### EXAMPLE EMBODIMENT

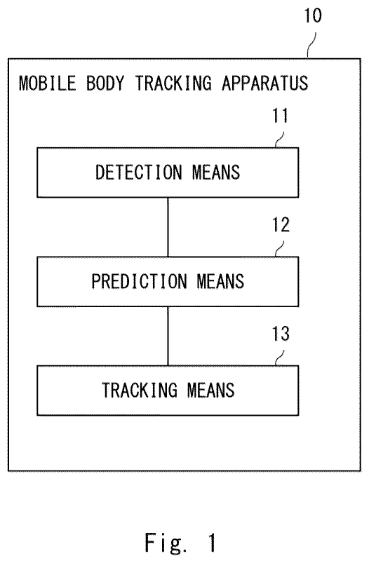

Prior to describing example embodiments of the present disclosure, an outline of the present disclosure will be described. FIG. 1 shows an example of a schematic configuration of a mobile body tracking apparatus according to the present disclosure. A mobile body tracking apparatus 10 includes detection means 11, prediction means 12, and tracking means 13. The detection means 11 detects a mobile body from each time-series image obtained by capturing images of a road. Note that the time-series images refer to, for example, two or more images captured continuously over a period of time by using the same image capturing apparatus. The time-series images include a first image and a second image captured at a time later than the time at which the first image has been captured.

The prediction means 12 predicts a destination area of the detected mobile body by using past information indicating the positions where mobile bodies have been detected on the road in the past. In a case where the mobile body is detected from the second image in the destination area that is predicted for the mobile body detected from the first image, the tracking means 13 tracks the mobile body detected from the first image and the mobile body detected from the second image as the same mobile body. Note that the tracking refers to, for example, associating the mobile bodies appearing in the images captured at different times with each other as the same mobile body.

In the present disclosure, the prediction means 12 predicts a destination area of the mobile body detected in the first image by using the positions where mobile bodies have been detected in the past. In a case where the mobile body is detected in the predicted destination area in the second image, the tracking means 13 tracks the mobile body detected from the first image and the mobile body detected from the second image as the same mobile body. In the present disclosure, it is possible to predict, as a destination area, an area including the positions where mobile bodies have been detected on the road in the past and therefore the mobile body is likely to pass through. Therefore, the mobile body tracking apparatus according to the present disclosure can accurately track the mobile body between time-series images.

The example embodiments according to the present disclosure will be described hereinafter in detail with reference to the drawings. Note that, in order to clarify the description, the following descriptions and the drawings are partially omitted and simplified as appropriate. Further, the same elements and similar elements are denoted by the same reference symbols throughout the drawings, and redundant descriptions are omitted as necessary.

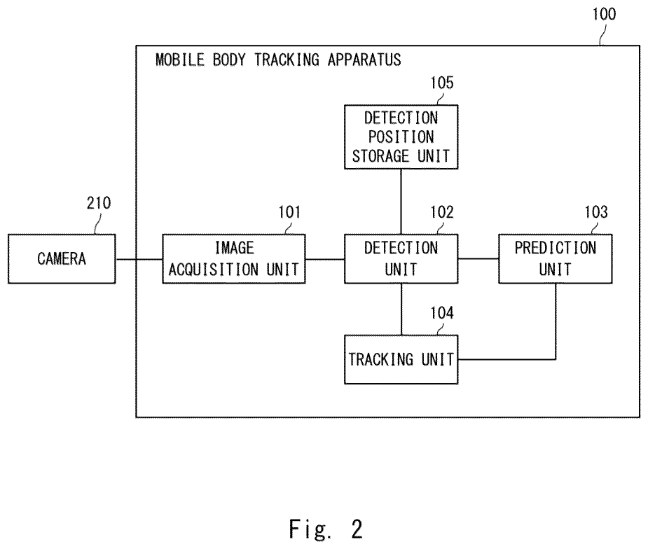

FIG. 2 shows a mobile body tracking apparatus according to an example embodiment of the present disclosure. A mobile body tracking apparatus 100 includes an image acquisition unit 101, a detection unit 102, a prediction unit 103, a tracking unit 104, and a detection position storage unit 105. The mobile body tracking apparatus 100 may be configured by using, for example, a computer including at least one processor and at least one memory. At least some of the functions of the respective units of the mobile body tracking apparatus 100 can be implemented by the processor operating in accordance with a program read from the memory.

The image acquisition unit 101 acquires time-series images from, for example, one or more cameras 210. The camera 210 captures an image of an area including a road. The camera 210 is installed in a roadside facility, such as a traffic signal, installed on a road. The image acquisition unit 101 acquires time-series images from the cameras 210 through a network. The network includes, for example, a network using a communication line standard such as Long Term Evolution (LTE). The network may include a wireless communication network such as WiFi (registered trademark) or a fifth generation mobile communication system.

The mobile body tracking apparatus 100 may be disposed, for example, at each intersection. Alternatively, one mobile body tracking apparatus 100 may be disposed so as to correspond to a predetermined geographic range, and the mobile body tracking apparatus 100 may receive time-series images from the camera 210 installed in an area within the predetermined geographic range. The image acquisition unit 101 may acquire, as the time-series images, three-dimensional point cloud data (three-dimensional point cloud images) acquired using, for example, light detection and ranging (LiDAR). The time-series images include, for example, a plurality of images obtained by capturing images of an intersection including the road in a time series. The time-series images include a first image and a second image. It is assumed that the second image is an image captured at a time later than the time at which the first image has been captured.

The detection unit 102 detects a mobile body from the time-series images acquired by the image acquisition unit 101. The detection unit 102 detects, for example, an area where the mobile body is included in the images as a position of the mobile body. A method used to detect the mobile body is not limited to any specific method. The detection unit 102 can detect a position of the mobile body using a known algorithm. In a case where a plurality of mobile bodies are included in the image, the detection unit 102 detects respective positions of the plurality of mobile bodies. The detection unit 102 may correct distortions of the image and the like, and detect absolute positions, that is, positions of the mobile bodies in a real space. Regarding the detected mobile bodies, the detection unit 102 may extract feature values from the image. The detection unit 102 corresponds to the detection means 11 shown in FIG. 1.

The detection unit 102 may identify a type of the detected mobile body. Examples of the types of the mobile body may include a private vehicle, a bus, a truck, a motorcycle, a bicycle, a person, and a streetcar. The types of the mobile body, for example, may be roughly classified as being a four-wheeled vehicle and a two-wheeled vehicle. In this case, a four-wheeled vehicle may be classified as being a large-sized vehicle, a standard-sized vehicle, or a small-sized vehicle. The detection unit 102 may analyze, for example, information about the shapes, the sizes, the colors, and the license plates of the mobile bodies, and identify or estimate a type of each of the detected mobile bodies. The detection unit 102, for example, may detect the mobile bodies by applying the image to an Artificial Intelligence (AI) model, thereby identifying the type of each of the mobile bodies.

The detection unit 102 stores the position of the detected mobile body in the detection position storage unit 105. The detection position storage unit 105 stores or accumulates, as past information, the positions of the detected mobile body, that is, the positions where mobile bodies have been detected. The detection position storage unit 105 may be configured by using, for example, a storage device such as a hard disk apparatus or a Solid State Drive (SSD). The detection position storage unit 105 may store the positions where mobile bodies have been detected for each type of mobile body. In other words, the detection position storage unit 105 may associate the positions where mobile bodies have been detected with the identified type of the mobile body and store them. Note that the detection position storage unit 105 does not need to be included in the mobile body tracking apparatus 100. For example, the detection position storage unit 105 may be configured as an external storage connected to the mobile body tracking apparatus 100 through the network.

The prediction unit 103 acquires past information, that is, data about the positions where mobile bodies have been detected at the intersection or on the road in the past from the detection position storage unit 105. The prediction unit 103 predicts, by using the acquired past information, a destination area of the mobile body detected by the detection unit 102 in the image captured at a later time. The prediction unit 103 predicts, for example, an area in front of the mobile body in the traveling direction and including the positions where mobile bodies have been detected in the past as a destination area.

For example, an image captured at a time t is defined as a first image, and an image captured at a time later than the time t, for example, at a time t+1, is defined as a second image. The prediction unit 103 predicts a position range of the mobile body detected in the first image in the second image, that is, a destination area, by using data about the positions where mobile bodies have been detected in the past. The prediction unit 103 predicts, for example, a position of the mobile body in the second image. The prediction unit 103 predicts, as a destination area of the mobile body in the second image, an area obtained by adding a predetermined margin to the predicted position and including the positions where mobile bodies have been detected in the past. The prediction unit 103 corresponds to the prediction means 12 shown in FIG. 1.

The prediction unit 103 may predict a plurality of directions in which the mobile body may travel based on the structure of the intersection and the position of the mobile body, and determine a plurality of predicted positions by using the predicted traveling directions. For example, in a case where the mobile body may turn right or go straight through the intersection, the prediction unit 103 may predict (i.e., determine) a predicted position of the mobile body for a case of turning right and a predicted position of the mobile body for a case of going straight. In this case, the prediction unit 103 may merge a destination area of the mobile body for the case of turning right with a destination area of the mobile body for the case of going straight, and predict the merged destination area as a destination area of the mobile body in the second image.

In a case where the detection position storage unit 105 stores past information, that is, the positions where mobile bodies have been detected in the past, for each type of mobile body, the prediction unit 103 may acquire the positions where mobile bodies have been detected in the past corresponding to the type of the detected mobile body and predict a destination area of the mobile body in the second image. For example, the positions where mobile bodies have been detected in the case where it is a large-sized vehicle may differ from those in the case where it is a standard-sized vehicle since there is a difference between the ways they travel at an intersection. Further, the positions where mobile bodies have been detected in the case where it is a four-wheeled vehicle may differ from those in the case where it is a two-wheeled vehicle since there is a difference between the ways they travel at an intersection. Therefore, it is considered that the accuracy of prediction of a destination area of the mobile body can be improved by predicting it using the positions where mobile bodies have been detected in the past corresponding to the type of the mobile body.

The prediction unit 103 may acquire a lighting state of a traffic signal installed in the intersection and predict a destination area of the mobile body in the second image based on the acquired lighting state. For example, the prediction unit 103 can acquire a lighting state of the traffic signal from the control panel of the traffic signal. The prediction unit 103 may analyze a camera image and acquire the lighting state. For example, in a case where the lighting state of the traffic signal indicates that vehicles cannot advance, the prediction unit 103 may predict that the mobile body will stop before the stop line and predict a destination area based on the prediction. Further, in a case where the lighting state of the traffic signal indicates that vehicles can advance only in a specific direction, the prediction unit 103 may predict that the mobile body will advance in the specific direction and predict a destination area based on the prediction.

The tracking unit 104 tracks the detected mobile body between the time-series images based on the position of the mobile body detected by the detection unit 102 and the destination area of the mobile body predicted by the prediction unit 103. The tracking unit 104 determines whether or not the mobile body is detected from the second image in the destination area predicted by the prediction unit 103 for the mobile body detected from the first image. In a case where the mobile body is detected in the predicted destination area, the tracking unit 104 tracks the mobile body detected in the first image and the mobile body detected in the second image as the same mobile body.

The tracking unit 104 may calculate a degree of similarity between the feature value of the mobile body detected in the first image and the feature value of the mobile body detected in the second image. The tracking unit 104 may determine that the mobile body detected in the first image and the mobile body detected in the second image are the same mobile body if the degree of similarity between the feature values is equal to or greater than a predetermined value. The result of the tracking by the tracking unit 104 can be used for, for example, traffic volume surveys and vehicle counts for each direction of travel. The tracking unit 104 corresponds to the tracking means 13 shown in FIG. 1.

Note that, in a case where the tracking unit 104 has already tracked the mobile body at a time before the time at which the first image has been captured, the prediction unit 103 may predict a position of the mobile body in the second image by using a result of the tracking of the mobile body. For example, the prediction unit 103 may calculate a moving speed and a moving direction of the mobile body from the result of the tracking of the past few frames, and determine a predicted position of the mobile body in the second image based on the calculated moving speed and moving direction. The moving speed can be calculated from, for example, a frame rate, that is, a time interval between the time-series images, and the amount of displacement or movement of the mobile body.

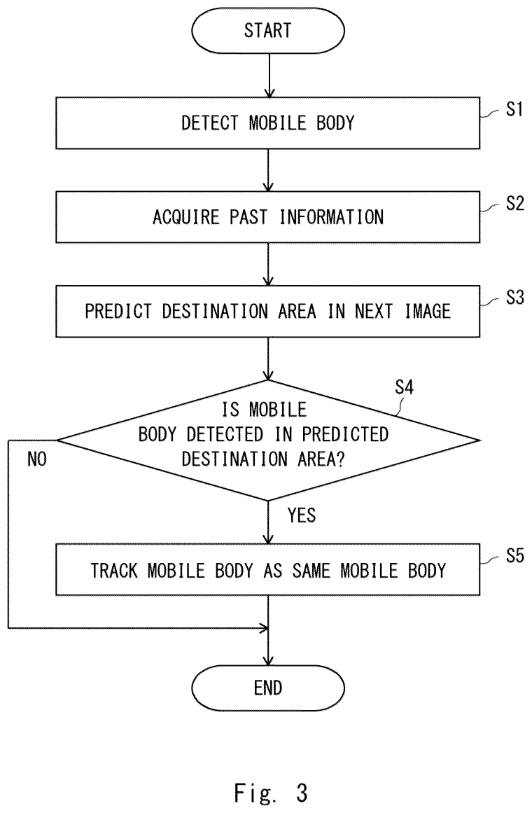

Next, an operation procedure will be described. FIG. 3 shows an operation procedure of the mobile body tracking apparatus 100. The operation procedure of the mobile body tracking apparatus 100 is also referred to as a mobile body tracking method. The camera 210 captures images of a road at an intersection. The image acquisition unit 101 acquires the images from the camera 210. The detection unit 102 detects a mobile body from the acquired image (Step S1). In Step S1, the detection unit 102 may estimate or identify the type of the mobile body. The prediction unit 103 acquires past information from the detection position storage unit 105 (Step S2). If the type of the mobile body is estimated or identified in Step S1, the prediction unit 103 may acquire past information corresponding to the estimated or identified type in Step S3.

The prediction unit 103 predicts a destination area of the mobile body detected in Step S1 in the next image by using the past information acquired in Step S2 (Step S3). In Step S3, for example, the prediction unit 103 predicts a position of the mobile body in the next image based on the position of the mobile body detected in Step S1. The prediction unit 103 predicts an area obtained by adding a margin to the predicted position and including the positions where mobile bodies have been detected in the past as a destination area.

The tracking unit 104 compares the position of the mobile body detected in Step S1 with a destination area predicted for a mobile body detected in the image in the past: for example, the image captured at one previous time. The tracking unit 104 determines whether or not the mobile body is detected in the predicted destination area. If the mobile body is detected in the predicted destination area, the tracking unit 104 detects the mobile body detected in Step S1 and the mobile body detected in the image captured at the time immediately before the time at which the image in which the mobile body is detected in Step 1 has been captured as the same mobile body (Step S5). If the mobile body is not detected in the predicted destination area, the tracking unit 104 determines that the mobile body detected in Step S1 and the mobile body detected in the image captured at the time immediately before the time at which the image in which the mobile body is detected in Step 1 has been captured are different mobile bodies.

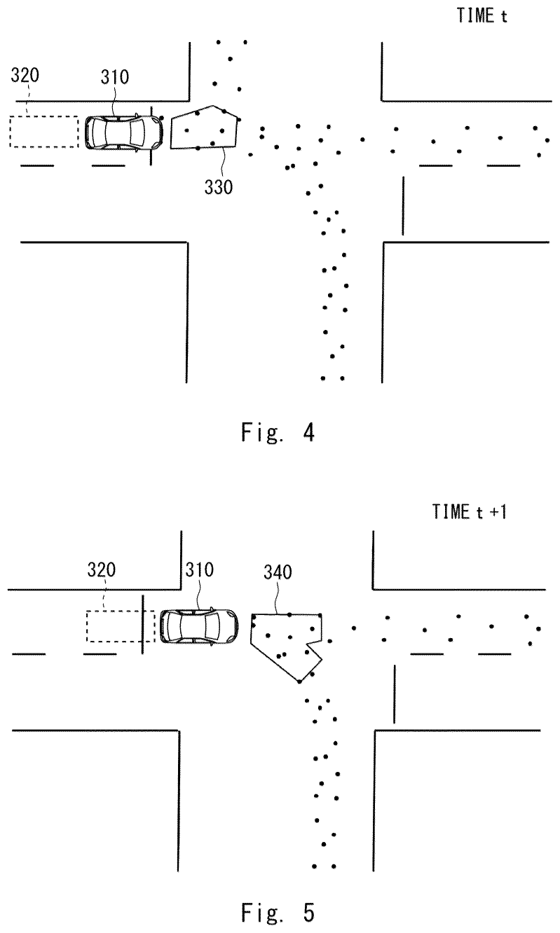

The description will be given below with reference to a specific example. FIG. 4 schematically shows a state of an intersection at the time t. A vehicle 310, which is a mobile body, is about to enter the intersection. In FIG. 4, the positions where mobile bodies have been detected in the past stored in the detection position storage unit 105 (see FIG. 1) are indicated by black circles. Note that, although not shown in FIG. 4 for the sake of simplicity, the detection position storage unit 105 also stores the positions where mobile bodies have been detected in the past in a lane opposite to the lane in which the vehicle 310 travels and a road crossing the road on which the vehicle 310 travels.

At the time t, the detection unit 102 detects the vehicle 310. It is assumed that, at a time t−1, the vehicle 310 has been detected at a detection position 320 indicated by a broken line. It is assumed that the tracking unit 104 tracks the vehicle 310 detected at the time t and a vehicle detected at the detection position 320 at the time t−1 as the same vehicle. In this case, the prediction unit 103 predicts a position of the vehicle 310 at the time t+1 based on the detection position of the vehicle 310 at the time t and the detection position 320 of the vehicle 310 in the image captured at the time t−1. The prediction unit 103 predicts, as a destination area of the vehicle 310 at the time t+1, an area 330 including the predicted position and the positions where mobile bodies have been detected in the past.

FIG. 5 schematically shows a state of the intersection at the time t+1. The detection unit 102 detects the vehicle 310 from the image captured at the time t+1. If the vehicle 310 is detected at the time t+1 in the area 330 (see FIG. 4) predicted at the time t, the tracking unit 104 tracks the vehicle detected at the time t and the vehicle detected at the time t+1 as the same vehicle.

At the time t+1, the vehicle 310 has entered nearly halfway into the intersection, and it can be predicted that the vehicle 310 will turn right or go straight through the intersection. The prediction unit 103 predicts a position of the vehicle 310 at a time t+2 for a case of turning right and for a case of going straight, respectively, based on the detection position of the vehicle 310 at the time t+1 and the detection position 320 of the vehicle 310 at the time t. The prediction unit 103 predicts, for a case of turning right and for a case of going straight, respectively, an area including the predicted position and the positions where mobile bodies have been detected in the past as a destination area of the vehicle 310 at the time t+1. The prediction unit 103 predicts, as a destination area of the vehicle 310 at the time t+2, an area 340 obtained by merging the destination area for a case of turning right with the destination area for a case of going straight.

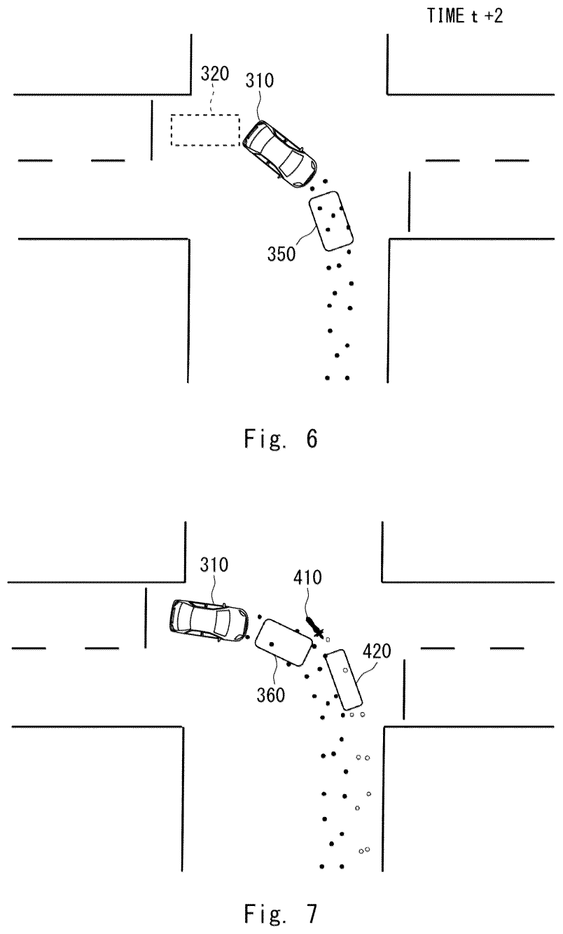

FIG. 6 schematically shows a state of the intersection at the time t+2. The detection unit 102 detects the vehicle 310 from the image captured at the time t+2. If the vehicle 310 is detected at the time t+2 in the area 340 (see FIG. 5) predicted at the time t+1, the tracking unit 104 tracks the vehicle detected at the time t+1 and the vehicle detected at the time t+2 as the same vehicle.

The vehicle 310 has changed its direction at the time t+2, and it can thus be predicted that the vehicle 310 will turn right at the intersection instead of going straight therethrough. The prediction unit 103 predicts a position of the vehicle 310 at a time t+3 based on the detection position of the vehicle 310 at the time t+2 and the detection position 320 of the vehicle 310 at the time t+1. The prediction unit 103 predicts, as a destination area of the vehicle 310 at the time t+3, an area 350 including the predicted position and the positions where mobile bodies have been detected in the past. If the vehicle 310 is detected at the time t+3 in the area 350 predicted at the time t+2, the tracking unit 104 tracks the vehicle detected at the time t+2 and the vehicle detected at the time t+3 as the same vehicle.

FIG. 7 schematically shows a state of the intersection in a certain situation. Note that, it is assumed that the detection position storage unit 105 stores the positions where a four-wheeled vehicle has been detected in the past and the positions where a two-wheeled vehicle has been detected in the past. In FIG. 7, the positions where the four-wheeled vehicle has been detected in the past are indicated by black circles, and the positions where the two-wheeled vehicle has been detected in the past are indicated by white circles. As shown in FIG. 7, the place where the four-wheeled vehicle passes through the intersection may differ from the place where the two-wheeled vehicle passes through the intersection.

The detection unit 102 detects the vehicle 310 which is the four-wheeled vehicle and a motorcycle 410 which is the two-wheeled vehicle. The prediction unit 103 predicts a position of the vehicle 310 and a position of the motorcycle 410 at the next time. Note that, it is assumed that the prediction unit 103 has predicted that the vehicle 310 and the motorcycle 410 will turn right at the intersection. For the vehicle 310, the prediction unit 103 predicts an area 360 including the predicted position and the positions where the four-wheeled vehicle has been detected in the past as a destination area of the vehicle 310. Meanwhile, for the motorcycle 410, the prediction unit 103 predicts an area 420 including the predicted position and the positions where the two-wheeled vehicle has been detected in the past as a destination area of the motorcycle 410.

In the above case, if the vehicle 310 is detected at the next time in the predicted area 360, the tracking unit 104 tracks the vehicle detected at the previous time and the vehicle detected at the next time as the same vehicle. Further, if the motorcycle 410 is detected at the next time in the predicted area 420, the tracking unit 104 tracks the motorcycle detected at the previous time and the motorcycle detected at the next time as the same motorcycle. By predicting a destination area of a mobile body in accordance with the type of the mobile body in this way, it becomes easy to track each type of mobile body in a case where places where mobile bodies pass through the intersection differ for each type of mobile body.

In this example embodiment, the detection position storage unit 105 stores the positions where mobile bodies have been detected in the past. The prediction unit 103 predicts a destination area of the mobile body detected in the first image by using the positions where mobile bodies have been detected stored in the detection position storage unit 105. In a case where the mobile body is detected in the predicted destination area in the second image, the tracking unit 104 tracks the mobile body detected from the first image and the mobile body detected from the second image as the same mobile body. In this example embodiment, the prediction unit 103 can predict, as a destination area of the mobile body, an area including the positions where mobile bodies have been detected in the past and therefore the mobile body is likely to pass through. Therefore, the mobile body tracking apparatus 100 according to this example embodiment can accurately track the mobile body in the first image and the second image.

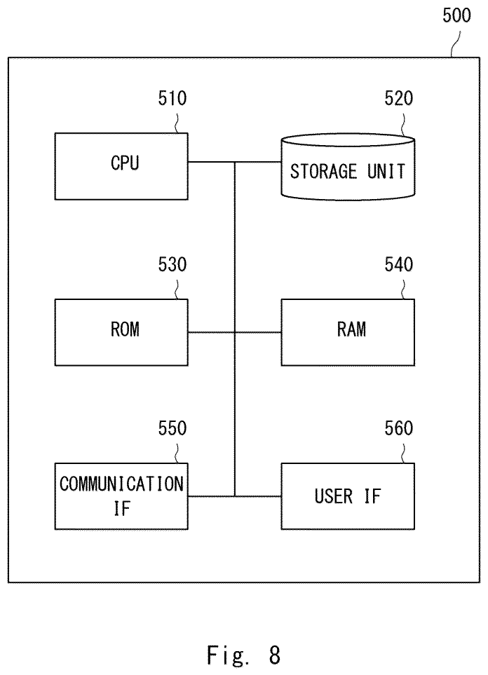

In the present disclosure, the mobile body tracking apparatus 100 may be configured as a computer apparatus or a server apparatus. FIG. 8 shows an example of a configuration of a computer apparatus that may be used as the mobile body tracking apparatus 100. A computer apparatus 500 includes a control unit (CPU: Central Processing Unit) 510, a storage unit 520, a Read Only Memory (ROM) 530, a Random Access Memory (RAM) 540, a communication interface (IF) 550, and a user interface 560.

The communication interface 550 is an interface for connecting the computer apparatus 500 to a communication network through wired communication means, wireless communication means, or the like. The user interface 560 includes, for example, a display unit such as a display. The user interface 560 also includes an input unit such as a keyboard, a mouse, and a touch panel.

The storage unit 520 is an auxiliary storage apparatus capable of holding various kinds of data. The storage unit 520 does not necessarily have to be a part of the computer apparatus 500. The storage unit 520 may be an external storage device or a cloud storage connected to the computer apparatus 500 through a network.

The ROM 530 is a non-volatile storage device. For example, a semiconductor storage device such as a flash memory having a relatively small capacity is used for the ROM 530. A program executed by the CPU 510 may be stored in the storage unit 520 or the ROM 530. The storage unit 520 or the ROM 530 stores, for example, various types of programs for implementing the functions of the respective units in the mobile body tracking apparatus 100.

The program can be stored and provided to the computer apparatus 500 using any type of non-transitory computer readable media. Non-transitory computer readable media include any type of tangible storage media. Examples of non-transitory computer readable media include magnetic storage media such as flexible disks, magnetic tapes, and hard disk drives, optical magnetic storage media such as magneto-optical disks, optical disk media such as a compact disc (CD) and a digital versatile disk (DVD), and semiconductor memories such as a mask ROM, a programmable ROM (PROM), an erasable PROM (EPROM), a flash ROM, and a RAM. Further, the program may be provided to a computer using any type of transitory computer readable media. Examples of transitory computer readable media include electric signals, optical signals, and electromagnetic waves. Transitory computer readable media can provide the program to a computer via a wired communication line such as electric wires and optical fibers or a wireless communication line.

The RAM 540 is a volatile storage device. Various types of semiconductor memory devices such as a Dynamic Random Access Memory (DRAM) or a Static Random Access Memory (SRAM) are used for the RAM 540. The RAM 540 may be used as an internal buffer that temporarily stores data and the like. The CPU 510 loads the program stored in the storage unit 520 or the ROM 530 into the RAM 540 and executes the loaded program. The CPU 510 executes the program, whereby the functions of the respective units in the mobile body tracking apparatus 100 may be implemented. The CPU 510 may include an internal buffer that can temporarily store data and the like.

Although the example embodiments according to the present disclosure have been described above in detail, the present disclosure is not limited to the above-described example embodiments, and the present disclosure also includes those that are obtained by making changes or modifications to the above-described example embodiments without departing from the scope and spirit of the present disclosure.

### REFERENCE SIGNS LIST

10: MOBILE BODY TRACKING APPARATUS
11: DETECTION MEANS
12: PREDICTION MEANS
13: TRACKING MEANS
100: MOBILE BODY TRACKING APPARATUS
101: IMAGE ACQUISITION UNIT
102: DETECTION UNIT
103: PREDICTION UNIT
104: TRACKING UNIT
105: DETECTION POSITION STORAGE UNIT
210: CAMERA
310: VEHICLE
410: MOTORCYCLE
500: COMPUTER APPARATUS
510: CONTROL UNIT
520: STORAGE UNIT
530: ROM
540: RAM
550: COMMUNICATION INTERFACE
560: USER INTERFACE

What is claimed is:

1. A mobile body tracking apparatus comprising:
at least one memory storing instructions; and
at least one processor configured to execute the instructions to:
detect a mobile body from each of time-series images obtained by capturing images of a road;
predict a destination area of the mobile body by using past information indicating positions where mobile bodies have been detected on the road in the past; and
track, in a case where the mobile body is detected from a second image in the destination area that is predicted for the mobile body detected from a first image included in the time-series images, the second image being captured at a time later than a time at which the first image has been captured, the mobile body detected from the first image and the mobile body detected from the second image as a same mobile body.

2. The mobile body tracking apparatus according to claim 1, wherein the at least one processor is configured to execute the instructions to predict a position of the mobile body at the time when the second image is captured, and predict an area including the predicted position and the positions where mobile bodies have been detected in the past information as the destination area.

3. The mobile body tracking apparatus according to claim 2, wherein in a case where the mobile body detected in the first image is a mobile body that is subsequently tracked from before the time at which the first image has been captured the at least one processor is configured to execute the instructions to calculate a moving speed and a moving direction of the mobile body by using a result of the tracking, and predict a position of the mobile body at the time when the second image is captured by using the calculated moving speed and moving direction.

4. The mobile body tracking apparatus according to claim 1, wherein
the past information is stored for each type of the mobile body, and
the at least one processor is configured to execute the instructions to predict the destination area by using the past information corresponding to the type of the detected mobile body.

5. The mobile body tracking apparatus according to claim 1, wherein the time-series images include a plurality of images obtained by capturing images of an intersection including the road in a time series.

6. The mobile body tracking apparatus according to claim 5, wherein the at least one processor is configured to execute the instructions to acquire a lighting state of a traffic signal installed in the intersection and predict the destination area based on the acquired lighting state.

7. The mobile body tracking apparatus according to claim 1, wherein the at least one processor is configured to execute the instructions to:
extract a feature value of the detected mobile body from the time-series images;
calculate a degree of similarity between the feature value of the mobile body detected in the first image and the feature value of the mobile body detected in the second image; and
track the mobile body detected from the first image and the mobile body detected from the second image as a same mobile body in a case where the calculated degree of similarity is equal to or greater than a predetermined value.

8. A mobile body tracking method comprising:
detecting a mobile body from a first image included in time-series images obtained by capturing images of a road;
predicting a destination area of the mobile body detected from the first image by using past information indicating positions where mobile bodies have been detected on the road in the past;
detecting the mobile body from a second image captured at a time later than a time at which the first image has been captured, the second image being included in the time-series images; and
tracking, in a case where the mobile body detected from the second image is detected in the destination area that is predicted for the mobile body detected from the first image, the mobile body detected from the first image and the mobile body detected from the second image as a same mobile body.

9. A non-transitory computer readable medium storing a program for causing a computer to execute processing including:
detecting a mobile body from a first image included in time-series images obtained by capturing images of a road;
predicting a destination area of the mobile body detected from the first image by using past information indicating positions where mobile bodies have been detected on the road in the past;
detecting the mobile body from a second image captured at a time later than a time at which the first image has been captured, the second image being included in the time-series images; and
tracking, in a case where the mobile body detected from the second image is detected in the destination area that is predicted for the mobile body detected from the first image, the mobile body detected from the first image and the mobile body detected from the second image as a same mobile body.
